(19) United States
(12) Patent Application Publication
(10) Pub. No.: US 2004/0231148 A1
(43) Pub. Date: Nov. 25, 2004

(54) Head for implanting electrical components on substrates

(76) Inventor: Walter Andersch, Kirchheim (DE)

Correspondence Address: HARNESS, DICKEY & PIERCE, P.L.C., P.O.BOX 8910, RESTON, VA, 20195, US

(21) Appl. No.: 10/491,106

(22) PCT Filed: Sep. 6, 2002
(86) PCT No.: PCT/DE02/03301

(30) Foreign Application Priority Data
Sep. 28, 2001 (DE) 101 47 922.0

(51) Int. Cl. B23P 19/00

(52) U.S. Cl. 29/749

(57) ABSTRACT

The invention relates to an insertion head 10 with a drive shaft 2 bearing a mechanism 5 for gripping a component 7, whereby said shaft is capable of being driven by a drive motor 1. The drive shaft 2 is directly formed by the hollow output shaft of the drive motor 1.

This application is the national phase under 35 U.S.C. § 371 of PCT International Application No. PCT/DE02/03301 which has an International filing date of Sep. 6, 2002, which designated the United States of America and which claims priority on German Patent Application number DE 101 47 922.0 filed Sep. 28, 2001, the entire contents of which is hereby incorporated herein by reference.

### FIELD OF THE INVENTION

The invention generally relates to an insertion head for inserting or implanting electrical components on substrates.

### BACKGROUND OF THE INVENTION

EP 1 050384 A1 discloses an insertion head for inserting components on substrates, wherein the individual components are held at a gripping mechanism in the nature of a vacuum nozzle. This is in turn attached to a quill or spindle in such a way that it can be replaced. The quill is located in the insertion head in such a way that it can be rotated and it is driven by a motor, which drives a reduction ring gear connected via a toothed belt to the quill in such a way that it cannot be rotated.

To change the rotational position of the quill and the component held by suction to the vacuum nozzle, the motor is controlled by an electronic control device. The quill and the vacuum nozzle connected to it can be moved in the insertion head in a direction that is perpendicular to the substrate by way of a slide that can be controlled by the electronic control device. A component held by suction to the vacuum nozzle can therefore be rotated about the axis of the quill and moved perpendicular to it. The insertion head can also be moved parallel to the plane of the substrate in the known manner.

One problem with such a known insertion head is that its structure is relatively complex, bulky and expensive and that because it is driven by the toothed belt, it is relatively susceptible to failure from the motor onward.

An insertion head for electronic components is also known through DE 3938088 A, wherein a shaft is supported in a housing in such a way that it can be rotated and moved in its longitudinal direction. One end of the shaft projecting from the housing has a hollow cone, into which the conical section of a replaceable vacuum nozzle can be fixed. The other end of the shaft is connected to an angular position measuring device.

The shaft has an iron core, which is surrounded by a coil held in the housing and which forms a lifting magnet together with this. The shaft is also fitted with permanent magnets serving as rotors, which form a brushless DC motor with a stator of the housing, by which the component can be rotated into an appropriate angular position. The rotor is displaced so far in the longitudinal direction of the shaft in relation to the stator that a magnetic bias results; which is modulated by the lifting magnets in order to be able to set a defined lifting force. A side connecting sleeve is used to supply a vacuum to hold the component to the vacuum nozzle by suction.

With such a relatively complicated, bulky and expensive insertion head the shaft primarily serves as a lift drive component. The rotor magnets are part of this lift drive. While the shaft is rotating, the magnetic conditions at the rotor change, so the axial forces also change as a result. The lifting movement, which has to be controlled precisely, cannot therefore take place while the shaft is rotating.

### SUMMARY OF THE INVENTION

An object of an embodiment of the present invention is therefore to configure an insertion head for inserting or implanting components on substrates such that it is comparatively simple and economical to produce.

One important advantage of the insertion head according to an embodiment of the invention, is that it can be produced in a relatively simple and economical design. This is because toothed wheels and toothed belts are not required to drive the quill or drive shaft bearing the gripping mechanism.

A further important advantage of an embodiment of the invention is that no additional bearing arrangements are required for the drive shaft bearing the gripping mechanism. This is because the drive shaft may be formed by the rotor shaft of the motor. As only very small rotational forces are required to rotate the components, the external dimensions of the motor, in particular the external diameter, can be made very small. As the rotational movement and lifting movement here take place using totally isolated drive systems, these movements can take place with temporal superimposition, which reduces the cycle time accordingly.

A further advantage of one embodiment is that, due to the configuration of the drive shaft of the drive motor as a quill, a pneumatic connection that is extremely favorable for assembly purposes can be fitted at the back end of the drive shaft.

One particular advantage is that the entire rotational unit can be configured as very compact and of low mass. It is therefore particularly suitable for forming an insertion head with a plurality of gripping mechanisms for a plurality of components. With such an insertion head the dimensions and in particular the distances between the gripping mechanisms can be kept very small. The mass of the insertion head, which has to be accelerated very significantly, remains correspondingly low.

In particular it is possible to provide such a multiple insertion head with a single shared lift drive for the individual gripping mechanisms in an economical manner.

With the insertion head according to an embodiment of the invention, the angular position measuring system, which indicates the angle of rotation of the drive shaft, can advantageously be integrated directly in the drive motor.

### BRIEF DESCRIPTION OF THE DRAWINGS

Further advantages, features and details of the invention will become evident from the description of illustrated exemplary embodiments given hereinbelow and the accompanying drawings, which are given by way of illustration only and thus are not limitative of the present invention, wherein:

FIG. 1 shows a schematic illustration of the side view of an insertion head according to an embodiment of the invention and

FIG. 2 shows a top view of the insertion head in FIG. 1.

### DETAILED DESCRIPTION OF THE PREFERRED EMBODIMENTS

The following considerations gave rise to an embodiment of the invention. As with regard to known insertion heads, with which the quill or spindle bearing the vacuum nozzle is driven for example via ring gears and a toothed belt from its own drive motor, there are problems in respect of the relatively complex and bulky design, susceptibility to failure due to the relatively large number of components and production costs, the idea was initially conceived of using the drive shaft of the drive motor as the spindle or quill bearing the vacuum nozzle. This results in a whole range of advantages.

The transmission mechanism present in known insertion heads between the drive motor and the spindle bearing the vacuum nozzle (ring gears on the spindle and on the drive motor, toothed belt) are not required. The entire arrangement of the insertion head can therefore be configured in a more compact manner.

As the spindle bearing the gripping mechanism is formed directly by the drive shaft of the drive motor, the bearing elements required with the prior art to support the spindle are no longer required.

A special angular position measuring system, which measures the rotation of the spindle bearing the gripping mechanism with known insertion heads, can be directly integrated in the drive motor with an embodiment of the present invention. For example this motor can be configured as a stepper motor, whereby the individual rotational steps are counted for angle measurement purposes.

As the transmission mechanism between the motor and drive shaft as mentioned above is no longer required, the errors generally occurring in relation to such a transmission mechanism can be avoided. With an embodiment of the present invention, the drive shaft is supported in the drive motor itself with zero backlash.

As with an embodiment of the present invention, the drive shaft can be in the form of a continuous hollow shaft with the vacuum nozzle attached to one side of it, the other side of the hollow shaft can be used to fit a pneumatic connection, e.g. by simple insertion.

An embodiment of the present invention can advantageously be used with different types of single and multiple insertion heads.

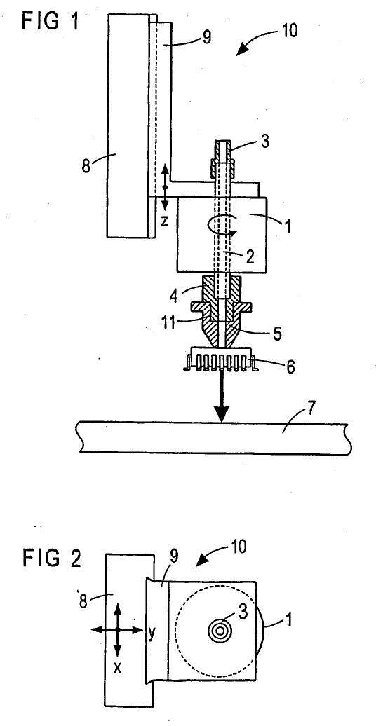

The insertion head according to an embodiment of the invention is marked 10 in FIGS. 1 and 2. It is used for inserting components 6 on a substrate 7, for example a printed circuit board. The insertion head 10 essentially includes a slide device 8, 9, which has two slide components 8 and 9 that can be moved toward each other in a Z direction, whereby the drive motor 1 is attached to one slide component 9. The drive motor 1 is preferably a stepper motor for example. An angular position measuring device 12 measures the rotation of the drive shaft 2 bearing the gripping mechanism and is integrated directly in the drive motor 1.

The drive shaft marked 2 of a rotor of the drive motor 1 is configured as a hollow shaft and can therefore be used as a quill or spindle, which can bear a gripping mechanism 5 configured as a vacuum nozzle on the side facing the substrate 7, when low pressure is generated in it. At the end of the drive shaft 2 away from the substrate 7 is a pneumatic connection 3, which is pushed onto the end area of the drive shaft 2 for example in the form of a connecting sleeve.

The slide component 8 can be moved in directions X and Y in the particular manner known shown in particular in FIG. 2, so that a component 6 held at the gripping mechanism 5 can be moved by appropriate control of the insertion head 10 to any position on the substrate 7 and be deposited by moving the slide component 9 in the Z direction on the substrate 7. The correct rotational position of the component 6 is achieved by rotating the drive motor 1 and the drive shaft 2.

As the drive shaft 2 is configured as relatively thin, it is expedient for the vacuum nozzles 5 not to be linked directly but via an adapter 4 to the drive shaft 2. The adapter 4 is connected permanently to the end area of the drive shaft 2 facing the substrate 7 and has a connecting area 11, the diameter of which is greater than the external diameter of the drive shaft 2. The gripping mechanism 5 can be fitted to the connecting area 11.

Reference Characters

1 Drive motor

2 Drive shaft

3 Pneumatic connection

4 Adapter

5 Gripping mechanism

6 Component

7 Substrate

8 Slide component

9 Slide component

10 Insertion head

11 Connecting area

12 Angular position measuring device

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Insertion head for inserting a component on a substrate, comprising:
at least one drive shaft, to which a gripping mechanism for the components is fixable, wherein the drive shaft is capable configured as a component of a rotor of a drive motor, wherein the drive motor with the drive shaft is attached to a slide component, movable in a direction perpendicular to the substrate in relation to a further slide component, and wherein the drive shaft is configured in a continuously hollow manner; and
a pneumatic connection, provided on a side of the drive shaft away from the gripping mechanism.

2. Insertion head according to claim 1, further comprising:
an adapter, arranged on the a side of the drive shaft facing the substrate, said adapter having a connecting area for the gripping mechanism, the external diameter of which is greater than the external diameter of the drive shaft.

3. Insertion head according to claim 1 wherein
the drive motor is a stepper motor.

4. Insertion head according to claim 1, further comprising:
an angular position measuring device, integrated in the drive motor, adapted to measure the rotational position of the drive shaft and a component held by suction at the gripper mechanism.

5. Insertion head according to claim 4, wherein
the angular position measuring device is adapted to determine the rotational position by detecting the rotational steps through which the drive shaft is rotated.

6. Insertion head according to claim 1, wherein the gripping mechanism is a vacuum nozzle.

7. Insertion head according to claim 2, wherein the gripping mechanism is a vacuum nozzle.

8. Insertion head according to claim 2, wherein the drive motor is a stepper motor.

9. Insertion head according to claim 2, further comprising:
an angular position measuring device, integrated in the drive motor, adapted to measure the rotational position of the drive shaft and a component held by suction at the gripper mechanism.

10. Insertion head according to claim 3, further comprising:
an angular position measuring device, integrated in the drive motor, adapted to measure the rotational position of the drive shaft and a component held by suction at the gripper mechanism.

11. Insertion head according to claim 4, wherein the gripping mechanism is a vacuum nozzle.

12. Insertion head according to claim 9, wherein the angular position measuring device is adapted to determine the rotational position by detecting the rotational steps through which the drive shaft is rotated.

13. Insertion head according to claim 10, wherein the angular position measuring device is adapted to determine the rotational position by detecting the rotational steps through which the drive shaft is rotated.

14. An insertion head for inserting a component on a substrate, comprising:
a mechanism for holding the component;
a drive motor, including at least one hollow drive shaft configured as a component of a rotor of a drive motor, the mechanism for holding the component being attachable to the drive shaft; and
a pneumatic connection, provided on a side of the drive shaft opposite the mechanism for holding the component.

15. An insertion head according to claim 14, wherein the drive motor with the drive shaft is attached to a slide component, movable in a direction perpendicular to the substrate in relation to a further slide component.

16. An insertion head according to claim 14, further comprising:
an adapter, arranged on a side of the drive shaft facing the substrate, said adapter having a connecting area for the mechanism for holding the component, the external diameter of which is greater than the external diameter of the drive shaft.

17. An insertion head according to claim 14, wherein the drive motor is a stepper motor.

18. An insertion head according to claim 14, further comprising:
an angular position measuring device, integrated in the drive motor, adapted to measure the rotational position of the drive shaft and a component held by suction at the mechanism for holding the component.

19. An insertion head according to claim 18, wherein the angular position measuring device is adapted to determine the rotational position by detecting the rotational steps through which the drive shaft is rotated.

20. An insertion head according to claim 14, wherein the mechanism for holding the component is a vacuum nozzle.
